(19) United States
(12) Patent Application Publication
(10) Pub. No.: US 2026/0059451 A1
(43) Pub. Date: Feb. 26, 2026

(54) WUR SUBCARRIERS-SPACING ADAPTATION & CONFIGURATION

(71) Applicant: Telefonaktiebolaget LM Ericsson (publ), Stockholm (SE)

(72) Inventors: Andreas Höglund, Solna (SE); Mohammad Mozaffari, Fremont, CA (US); Yanpeng Yang, Järfälla (SE); Kittipong Kittichokechai, Järfälla (SE)

(21) Appl. No.: 19/483,321

(22) PCT Filed: May 8, 2024
(86) PCT No.: PCT/SE2024/050448

§ 371 Date: Nov. 11, 2025

Related U.S. Application Data
(60) Provisional application No. 63/501,927, filed on May 12, 2023.

(51) Int. Cl. H04W 52/02; H04W 72/0453

(52) U.S. Cl. CPC H04W 52/0235; H04W 52/028; H04W 72/0453

(57) ABSTRACT

A method for configuring one or more bandwidth parameters of a Wake-Up Signal (WUS) for a Wake-Up Receiver (WUR) of a User Equipment (UE) to reduce interference with other downlink transmissions. The base station device serving the UE can determine one or more bandwidth parameters (e.g., number of subcarriers, number of resource blocks, sub-carrier spacing, etc.) for the WUS and signal those bandwidth parameters to the UE. Then, when transmitting the WUS according to the bandwidth parameters, the UE can easily decode the WUS and start monitoring during the paging occasion. In one or more embodiments, the base station device can determine the bandwidth parameters based at least in part on the UE capability information which the UE can provide to the base station device.

### RELATED APPLICATIONS

This application claims the benefit of provisional patent application Ser. No. 63/501,927, filed May 12, 2023, the disclosure of which is hereby incorporated herein by reference in its entirety.

### TECHNICAL FIELD

The present disclosure relates to a method for configuring one or more bandwidth parameters of a Wake-Up Signal for a Wake-Up Receiver of a User Equipment to reduce interference with other downlink transmissions.

### BACKGROUND

Wake-up receiver (WUR), sometimes also referred to as “wake-up radio”, is about enabling a low power receiver in User Equipment devices (UEs), which, in case of the detection of a wake-up signal (WUS), wakes up the main (baseband/higher power) receiver to detect an incoming message, typically paging (e.g., Physical Downlink Control Channel (PDCCH) in paging occasions (PO), scheduling the paging message on Physical Downlink Shared Channel (PDSCH)). The main benefit of employing WUR is lowering energy consumption and longer device battery life, or at a fixed energy consumption the downlink latency can be reduced (shorter Discontinuous Reception (DRX)/duty-cycles and more frequent checks for incoming transmissions).

### WUS for NB-IoT and LTE-M

In Rel-15 WUS was specified for Narrowband Internet of Things (NB-IoT) and Long Term Evolution for Machines (LTE-M). The main motivation was UE energy consumption reduction since with the coverage enhancement PDCCH could be repeated many times and the WUS is relatively much shorter and hence requires less reception time for the UE. The logic is that a UE would check for a WUS a certain time before its PO, and only if a WUS is detected the UE would continue to check for PDCCH in the PO, and if not, which is most of the time, the UE can go back to a sleep state to conserve energy. Due to the coverage enhancements, the WUS 202 can be of variable length, while the PO 204 is constant length, depending on the UE's coverage, see FIG. 2.

A WUS is based on the transmission of a short signal that indicates to the UE that it should continue to decode the DL control channel e.g., full Narrowband Physical Downlink Control Channel (NPDCCH) for NB-IoT. If such signal is absent (DTX i.e., UE does not detect it) then the UE can go back to sleep without decoding the Downlink (DL) control channel. The decoding time for a WUS is considerably shorter than that of the full NPDCCH since it essentially only needs to contain one bit of information whereas the NPDCCH may contain up to 35 bits of information. This, in turn, reduces UE power consumption and leads to longer UE battery life. The WUS would be transmitted only when there is a paging for the UE. But if there is no paging for the UE then the WUS will not be transmitted (i.e., implying a discontinuous transmission, DTX) and the UE would go back to deep sleep e.g., upon detecting DTX instead of WUS. This is illustrated in FIG. 1, where 102-1, 102-3, 104-1 and 104-3 indicate possible WUS and PO positions whereas the boxes 102-2 and 104-2 indicate actual WUS and PO positions respectively.

The specification of Rel-15 WUS is spread out over several parts of the LTE 36-series standard, e.g., 36.211, 36.213, 36.304 and 36.331.

A UE will report its WUS capability to the network, and WUS gap capability (see below). Further WUS information was added to the paging message/request from Mobility Management Entity (MME) to Enhanced or Evolved Node B (eNB) (see UE radio paging capabilities). eNB will use WUS for paging the UE if and only if 1) WUS is enabled in the cell (i.e., WUS-Config present in SI), and 2) the UE supports WUS according to the wakeUpSignal-r15 UE capability (see also the description of WUS gap below).

WUS was introduced for both LTE-M and NB-IoT with support for both Discontinuous Reception (DRX) and eDRX, the former with a 1-to-1 mapping between the WUS and the PO, and for the latter in an addition with the possible configuration of 1-to-N (many) POs. eNB can configure one WUS gap for UEs using DRX, and another one for UEs using eDRX [TS 36.331, examples are given for NB-IoT, LTE-M is similar]:

WUS-Config-NB information element:

| WUS-Config-NB-r15 ::= | SEQUENCE { | |
|---|---|---|
| maxDurationFactor-r15 | WUS-MaxDurationFactor-NB-r15, | |
| numPOs-r15 | ENUMERATED {n1, n2, n4} | DEFAULT n1, |

| | |
|---|---|
| numDRX-CyclesRelaxed-r15 | ENUMERATED {n1, n2, n4, n8}, |
| timeOffsetDRX-r15 | ENUMERATED {ms40, ms80, ms160, ms240}, |
| timeOffset-eDRX-Short-r15 | ENUMERATED {ms40, ms80, ms160, ms240}, |
| timeOffset-eDRX-Long-r15 | ENUMERATED {ms1000, ms2000} |

```
  OPTIONAL, -- Need OP
    ...
  }
```

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, one64th, |

one32th, one16th,

oneEighth, oneQuarter, oneHalf}

WUS-Config-NB field descriptions

timeOffsetDRX—When DRX is used, non-zero gap from the end of the configured maximum WUS duration to the associated PO, see TS 36.304 [4], clause 7.4 and TS 36.211 [21]. In milliseconds. Value ms40 corresponds to 40 ms, value ms80 corresponds to 80 ms and so on.

timeOffset-eDRX-Short—When eDRX is used, the short non-zero gap from the end of the configured maximum WUS duration to the associated PO, see TS 36.304 [4], clause 7.4 and TS 36.211 [21]. In milliseconds. Value ms40 corresponds to 40 ms, value ms80 corresponds to 80 ms and so on. E-UTRAN configures timeOffset-eDRX-Short to a value longer than or equal to timeOffsetDRX.

timeOffset-eDRX-Long When eDRX is used, the long non-zero gap from the end of the configured maximum WUS duration to the associated PO, see TS 36.304 [4], clause 7.4 and TS 36.211 [21]. In milliseconds. Value ms1000 corresponds to 1000 ms, value ms2000 corresponds to 2000 ms.

The UE capabilities can also indicate the minimum WUS gaps required for the UE to be able to decode PDCCH in the associated PO, for DRX and eDRX, respectively [TS 36.331]:

UE-RadioPagingInfo-NB information element:

| | |
|---|---|
| UE-RadioPagingInfo-NB-r13 ::= | SEQUENCE { |
| ue-Category-NB-r13 | ENUMERATED {nb1} |

```
  OPTIONAL,
    ...,
```

| | |
|---|---|
| [[ multiCarrierPaging-r14 | ENUMERATED {true} |

```
  OPTIONAL
    ]],
```

| | | |
|---|---|---|
| [[ | mixedOperationMode-r15 | ENUMERATED {supported} |

OPTIONAL,

| | |
|---|---|
| wakeUpSignal-r15 | ENUMERATED {true} |

OPTIONAL,

| | |
|---|---|
| wakeUpSignalMinGap-eDRX-r15 | ENUMERATED {ms40, ms240, |

| | |
|---|---|
| ms1000, ms2000} | OPTIONAL, |

| | |
|---|---|
| multiCarrierPagingTDD-r15 | ENUMERATED {true} |

```
  OPTIONAL
    ]],
```

| | | |
|---|---|---|
| [[ | ue-Category-NB-r16 | ENUMERATED {nb2} |

OPTIONAL,

| | |
|---|---|
| groupWakeUpSignal-r16 | ENUMERATED {true} |

OPTIONAL,

| | |
|---|---|
| groupWakeUpSignalAlternation-r16 | ENUMERATED {true} |

```
  OPTIONAL
    ]]
  }
  UE-RadioPagingInfo-NB information element
```

wakeUpSignalMinGap-eDRX Indicates the minimum gap the UE supports between WUS or GWUS and associated PO in case of eDRX in FDD, as specified in TS 36.304 [4]. Value ms40 corresponds to 40 ms, value ms240 corresponds to 240 ms and so on. If this field is included, the UE shall also indicate support for WUS or GWUS for paging in DRX.

At the end of Rel-15, a longer WUS gap of 1 s or 2 s was introduced to enable the use of WUR. That is, starting up the main baseband receiver if a WUR is used for the detection of WUS may take longer time. If this is supported in the cell, eNB would include timeOffset-eDRX-Long in the WUS-Config in SI (see above). In TS 36.304 the UE behavior for monitoring paging with WUS is specified, and in Table 7.4-1 in the portion highlighted below, it is indicated which WUS time gap the UE (and eNB) should apply depending on the reported UE capability:

7.4 Paging with Wake Up Signal

Paging with Wake Up Signal is only used in the cell in which the UE most recently entered RRC_IDLE triggered by:
reception of RRCEarlyDataComplete; or
reception of RRCConnectionRelease not including noLastCellUpdate; or
reception of RRCConnectionRelease including noLastCellUpdate and the UE was using (G) WUS in this cell prior to this RRC connection attempt.

If the UE is in RRC_IDLE, the UE is not using GWUS according to clause 7.5 and the UE supports WUS and WUS configuration is provided in system information, the UE shall monitor WUS using the WUS parameters provided in System Information. When DRX is used and the UE detects WUS the UE shall monitor the following PO. When extended DRX is used and the UE detects WUS the UE shall monitor the following numPOs POs or until a paging message including the UE's NAS identity is received, whichever is earlier. If the UE does not detect WUS the UE is not required to monitor the following PO(s). If the UE missed a WUS occasion (e.g. due to cell reselection), it monitors every PO until the start of next WUS or until the PTW ends, whichever is earlier.
numPOs=Number of consecutive Paging Occasions (PO) mapped to one WUS provided in system information where (numPOs≥1).

The WUS configuration, provided in system information, includes time-offset between end of WUS and start of the first PO of the numPOs POs UE is required to monitor. The timeoffset in subframes, used to calculate the start of a subframe g0 (see TS 36.213 [6]), is defined as follows:
for UE using DRX, it is the signalled timeoffsetDRX;
for UE using eDRX, it is the signalled timeoffset-eDRX-Short if timeoffset-eDRX-Long is not broadcasted;
for UE using eDRX, it is the value determined according to Table 7.4-1 if timeoffset-eDRX-Long is broadcasted.

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms or | timeoffset- | timeoffset- |
| wakeUpSignalMinGap- | not | eDRX-Short | eDRX-Short |
| eDRX | reported | | |
| | 240 ms | timeoffset- | timeoffset- |
| | | eDRX-Short | eDRX-Short |
| | 1000 ms | timeoffset- | timeoffset- |
| | | eDRX-Long | eDRX-Long |
| | 2000 ms | timeoffset- | timeoffset- |
| | | eDRX-Short | eDRX-Long |

The timeoffset is used to determine the actual subframe g0 as follows (taking into consideration resultant SFN and/or H-SFN wrap-around of this computation):

g0=PO−timeoffset, where PO is the Paging Occasion subframe as defined in clause 7.1

For UE using eDRX, the same timeoffset applies between the end of WUS and associated first PO of the numPOs POs for all the WUS occurrences for a PTW.

The timeoffset, g0, is used to calculate the start of the WUS as defined in TS 36.213 [6].

In essence, as illustrated in FIG. 3, the UE will only use WUR, or timeOffset-eDRX-Long 302, if it is capable of starting up the main receiver as quickly as indicated by the value used in SI. If not, it will fall back to using timeOffset-eDRX-Short 304 (without WUR).

### WUS UE Grouping Objective in Rel-16

In the Rel-16 WID, it was agreed that WUS should be further developed to also include UE grouping, such that the number of UEs that are triggered by a WUS is further narrowed down to a smaller subset of the UEs that are associated with a specific paging occasion (PO):

The objective is to specify the following set of improvements for machine-type communications for BL/CE UEs.
Improved DL Transmission Efficiency and/or UE Power Consumption:
. . .
Specify support for UE-group wake-up signal (WUS) [RAN1, RAN2, RAN4]

The purpose is to reduce the false paging rate, i.e., avoid that a given UE is unnecessarily woken up by a WUS transmission intended for another UE. This feature is referred to as Rel-16 group WUS, or GWUS. However, this is not directly related to WUR and will not further be explained here.

### Rel-17 NR PEI

In Rel-17 discussions started on introducing a WUS for NR, then called “Paging Early Indication” (PEI). However, since at the time no coverage enhancement was specified for NR, the only gain for Rel-17 PEI was for scenarios where the small fraction of UEs are in bad coverage and with large synchronization error due to the use of longer DRX cycles. The gain for such UEs were that with the use of PEI they would typically only have to acquire one Synchronization Signal Block (SSB) before decoding PEI, instead of up to 3 SSBs if PEI is not used (value according to UE vendors). So, for most UEs, Rel-17 PEI will result in gains or increased performance.

Rel-17 PEI will also support UE grouping for false paging reduction, similar to the Rel-16 GWUS above, which will have some gains at higher paging load.

In RAN #93e it was agreed that PEI will be PDCCH-based, as seen in from the next subsection, making it much less interesting for WUR (i.e., the main baseband receiver is required for decoding PEI).

### Rel-18 NR WUR

In Rel-18, there has been rather large interest to introduce WUR for NR. As explained above, the only specification support needed to be able to use a WUR in the UE, is the specification of a WUS and a long enough time gap between the WUS and the PDCCH in the PO (to allow the UE to start up the main receiver). Therefore, the main difference to Rel-17 PEI is the WUS in Rel-18 should not be PDCCH-based and allow for a simpler and low power receiver, i.e., WUR with simple modulation and detection techniques (e.g., using on-off keying, (OOK) modulation and non-coherent detection).

In Rel-18, a study item on “low-power wake-up signal and receiver for NR” was approved. The relevant justification and objective sections are copied below from (RP-213645):

### Justification

5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life is a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

Currently, UEs need to periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

The power consumption for monitoring wake-up signal depends on the wake-up signal design and the hardware module of the wake-up receiver used for signal detecting and processing.

The study should primarily target low-power WUS/WUR for power-sensitive, small form-factor devices including IoT use cases (such as industrial sensors, controllers) and wearables. Other use cases are not precluded, e.g. XR/smart glasses, smart phones.

### Objective of SI

As opposed to the work on UE power savings in previous releases, this study will not require existing signals to be used as WUS. All WUS solutions identified shall be able to operate in a cell supporting legacy UEs. Solutions should target substantial gains compared to the existing Rel-15/16/17 UE power saving mechanisms. Other aspects such as detection performance, coverage, UE complexity, should be covered by the evaluation.

The study item includes the following objectives:
Identify evaluation methodology (including the use cases) & KPIs [RAN1]
   a. Primarily target low-power WUS/WUR for power-sensitive, small form-factor devices including IoT use cases (such as industrial sensors, controllers) and wearables
      i. Other use cases are not precluded
Study and evaluate low-power wake-up receiver architectures [RAN1, RAN4]
Study and evaluate wake-up signal designs to support wake-up receivers [RAN1, RAN4]
Study and evaluate L1 procedures and higher layer protocol changes needed to support the wake-up signals [RAN2, RAN1]
Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study [RAN1]

Note: The need for RAN2 evaluation will be triggered by RAN1 when necessary.

For more details on e.g. suggestions on WUR architecture and design, receiver power vs. sensitivity trade-off see e.g. RP-212005, RP-212254, RP-212367, and RP-212427 which were submitted to RAN3 #93-e.

The benefit of WUR is to reduce the energy consumption of the receiver, such that unless there is any paging and data for the UE it can remain in a power saving state. This will extend the battery life of the device, or alternatively enable shorter downlink latency (shorter DRX) at a fixed battery life. For short-range communication, the WUR power can be low enough (˜3 uW) that this can even, in combination with energy harvesting, enable that the WUR is continuously on (i.e. DRX or duty-cycling is not used) without the need for a battery. This can be considered as a key enabler of battery-less devices towards Sixth Generation (6G).

### IEEE WUR

In Institute of Electrical and Electronics Engineers (IEEE), the support for WUR has been specified to a greater extent than in Third Generation Partnership Project (3GPP). That is, the focus was on low power WUR from the start and the design uses WUR not only for receiving the WUS but also other control signals and signaling, such as synchronization and mobility information. This allows the stations (corresponding to UEs in 3GPP) to only use the WUR when there is no user-plane data transmission ongoing.

Similar to the 3GPP solution, the use of WUR is only enabled in stations and not in access points (APs), that is for downlink communication only. The AP advertises that it has WUR operation capability, along with WUR configuration parameters (among other info, in which band/channel WUR is operational, which can be different from the band/channel used for data transmission using the main receiver, e.g., WUR in 2.4 GHz band but data communication in 5 GHz band. Also note that the WUR operating channel is advertised in the beacon, and that the WUR discovery operating channel may be different from the WUR operating channel.). Stations can then request to be configured with WUR mode of operation. This request has to be granted by the AP, and in case it is granted, the station is further configured/setup for WUR mode of operation (the configuration is only valid for the connection to the associated AP, and further the configuration must be torn down/de-configured if WUR is not to be used anymore). Both continuous WUR (receiver open all the time) and duty-cycled WUR (receiver only open during preconfigured time slots) mode of operations are supported. For the latter the length of the duty-cycles and on-time during wake up is part of the WUR configuration.

Unlike the 3GPP solution, the WUR operation mode is a “sub-state” of the regular operation and upon the detection of a WUS transmission from the AP, the station will resume the power saving mechanism it was configured with before entering the WUR operation mode. That is, IEEE has specified a number of different power saving mechanisms, and for example if duty-cycled monitoring of the downlink has been configured for the station it will switch to that upon detection of the WUS (i.e., unlike the specified 3GPP mechanism which only covers paging, and the UE will continue to monitor PDCCH if WUS is detected). In this way the IEEE WUR functionality is more general, and stills allows for the station to upon detection of WUS “monitor paging” by checking in the beacon from the AP for which stations there is data, or for the station to directly respond with an uplink transmission.

A station receiving the IEEE WUS must synchronize to the wireless medium prior to performing any transmissions, i.e., using sync info in the beacon from the AP (typically transmitted every 100 ms) or from the transmission to another station. Synchronization to the wireless medium refers to the following in IEEE 802.11; a station changing from sleep to awake in order to transmit must perform channel clear assessment until it receives one or more frames that allow it to correctly set the virtual carrier sensing. This is to prevent collisions with transmissions from hidden nodes. (Essentially the virtual carrier sensing tells a station to defer for a time period even if the wireless medium appears to be idle, and can be set by receiving frames that indicate the duration of an ongoing frame exchange). Note that in WiFi typically one beacon transmission is enough to sync for the station (i.e., no need to acquire several transmission due to poor coverage). (Unlike operation in licensed bands, the station also has to apply carrier sensing, and also possibly re-acquire channel sensing parameters, before uplink transmission).

The physical WUS in IEEE contains complete frames which much be processed by the station. The drawback with this design is that it requires more processing and handling and processing in the station, i.e., compared to a simple WUR design which trigger one pre-defined activity in case WUS is detected. The benefit is that it contains more information and the solution is more general. The IEEE WUS contains information to indicate if the WUS is a WUR sync beacon (see below), a WUR discovery beacon (see below), or a regular WUS (intended to wake the station up). The WUS can also contain proprietary frames, which could e.g., be used to directly turn actuators on/off. The transmission uses on/off keying (OOK) modulation, using Manchester coding, but is using multi-carrier OOK which can be generated by an OFDM transmitter (i.e., WUR can be enabled as a software upgrade in APs). The WUS is 4 MHz wide, but a whole 20 MHz channel is reserved. The WUS starts with a 20 MHz legacy preamble (to allows other stations to perform carrier sense) followed by 4 MHz Manchester coded OOK. Two data rates are supported: 62.5 kbps and 250 kbps, and link adaptation is up to the AP (each packet is self-contained and includes the data rate, i.e. in the WUR there are two possible sync words used to signal the data rate).

The WUS can contain the following information:
Station ID, or group ID (grouping of stations is supported)
Payload up to 22 bytes.
Short frames contain only basic info; which WUR frame type+addressing.
Ordinary frames contain control info, and in addition proprietary info.
WUR beacons contain BSS-ID, sync information, time counter.
Similar structure for WUS and WUR beacons (sync words indicate the data rate, the station can then detect the header, from this the station can tell if it is WUS or beacon, then check body).
WUR discovery frames contain mobility related information to allow for lower power scan (see below).

Regarding mobility, both WUR sync beacons and WUR discovery beacons has been specified, which only requires the WUR to be used for reception, such that stations can stay in the WUR operation mode unless there is data transmission for the station. I.e., stations only need to switch back to legacy PSM upon WUS detection (or when moving to a new AP). WUR sync beacons are used by stations to obtain rough synchronization (for data transmission the legacy beacon must still be acquired), and WUR discovery beacons are used to carry (legacy) mobility information to enable quick/low energy scanning (allowing stations, only using the WUR, to get information related to local and roaming scans for nearby APs, e.g., SSID and main radio operating channels, if the channel quality should deteriorate).

That is, in the WUR discovery beacon the AP can indicate one or more BSS (basic service set, and the BSS-ID has a one-to-one mapping with the assigned SSID name) in which WUR is supported such that stations do not have to scan all frequencies/channels. Since the WUR discovery beacon contains the legacy mobility information, which means there is some duplication/redundancy in the broadcasted information. This allows for low power scanning, using only the WUR. Note however that mobility in IEEE is restricted to the same AP, and that hand-over between APs etc. is not supported in the same way as in 3GPP. If a station in WUR operation mode moves to a new AP, it would have to move out of WUR operation mode and use the main receiver to obtain the beacon, sync, configuration, and associate to the new AP.

### SUMMARY

The present disclosure relates to a method for configuring one or more bandwidth parameters of a Wake-Up Signal (WUS) for a Wake-Up Receiver (WUR) of a User Equipment (UE) to reduce interference with other downlink transmissions. The base station device serving the UE can determine one or more bandwidth parameters (e.g., number of subcarriers, number of resource blocks, sub-carrier spacing, etc.) for the WUS and signal those bandwidth parameters to the UE. Then, when transmitting the WUS according to the bandwidth parameters, the UE can easily decode the WUS and start monitoring during the paging occasion. In one or more embodiments, the base station device can determine the bandwidth parameters based at least in part on the UE capability information which the UE can provide to the base station device.

In an embodiment, a method performed by a base station device can be provided, where the base station device configures one or more bandwidth parameters of a WUS for a WUR of a UE to reduce interference with other downlink transmissions. The method includes determining one or more bandwidth parameters of the WUS, signaling the one or more bandwidth parameters to the UE, and transmitting the WUS based on the one or more bandwidth parameters of the WUS.

In an embodiment, the method includes receiving UE capability information from the UE; and determining the one or more bandwidth parameters of the WUS based on the UE capability information.

In an embodiment, the one or more bandwidth parameters comprise one or more of a number of subcarriers, a number of resource blocks, and Subcarrier Spacing (SCS).

In an embodiment, the determining the one more bandwidth parameters of the WUS is based on a maximum supported bandwidth of the WUR of the UE.

In an embodiment, the number of subcarriers or the number of resource blocks are determined based on a fixed SCS.

In an embodiment, the fixed SCS is an SCS of an initial downlink bandwidth part.

In an embodiment, the fixed SCS is different than an SCS of an initial downlink bandwidth part.

In an embodiment, the determining the one more bandwidth parameters is based on a fixed number resource blocks and a variable SCS.

In an embodiment, the variable SCS is based on an SCS of a Synchronization Signal Physical Broadcast Channel block (SSB).

In an embodiment, the signaling the one or more bandwidth parameters to the UE is via a System Information Block or via dedicated Radio Resource Control configuration.

In an embodiment, a base station device that configures one or more bandwidth parameters of a WUS for a WUR of a UE to reduce interference with other downlink transmissions is provided. The base station device includes a radio interface and processing circuitry associated with the radio interface, wherein the processing circuitry is configured to cause the base station device to determine one or more bandwidth parameters of the WUS, signal the one or more bandwidth parameters to the UE, and transmit the WUS based on the one or more bandwidth parameters of the WUS.

In an embodiment, a method is provided that is performed by a UE for detecting a WUS for a WUR. The method includes receiving an indication of one or more bandwidth parameters associated with the WUS from a base station device; decoding a transmission based on the one or more bandwidth parameters, resulting in a decoded transmission comprising the WUS; and in response to the decoded transmission comprising the WUS, monitoring for a subsequent downlink transmission.

In an embodiment, the method includes determining an additional bandwidth parameter based on the one or more bandwidth parameters; and decoding the transmission based on the one or more bandwidth parameters and the additional bandwidth parameter.

In an embodiment, the method includes receiving the indication of the one or more bandwidth parameters via a System Information Block or via dedicated Radio Resource Control configuration.

In an embodiment, the one or more bandwidth parameters comprise one or more of a number of subcarriers, a number of resource blocks, and Subcarrier Spacing (SCS).

In an embodiment, the method includes providing UE capability information to the base station device.

In an embodiment, a UE for detecting a WUS for a WUR is provided, where the UE includes a radio interface and processing circuitry associated with the radio interface, wherein the processing circuitry is configured to cause the UE to receive an indication of one or more bandwidth parameters associated with the WUS from a base station device; decode a transmission based on the one or more bandwidth parameters, resulting in a decoded transmission comprising the WUS; and in response to the decoded transmission comprising the WUS, monitor for a subsequent downlink transmission.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of a location of a Wake-Up Signal (WUS) and a paging location;

FIG. 2 shows an example of a variable length WUS;

FIG. 3 shows an example of variable length WUS gaps;

FIG. 4 shows an example of WUS and other transmissions within a channel bandwidth in accordance with some embodiments of the present disclosure;

FIG. 5 shows an example of a message sequence chart for configuring one or more bandwidth parameters of a WUS in accordance with some embodiments of the present disclosure;

FIG. 6 shows an example of a communication system in accordance with some embodiments of the present disclosure;

FIG. 7 shows a User Equipment (UE) in accordance with some embodiments of the present disclosure;

FIG. 8 shows a network node in accordance with some embodiments of the present disclosure;

FIG. 9 is a block diagram of a host, which may be an embodiment of the host of FIG. 6, in accordance with various aspects of the present disclosure described herein; and

FIG. 10 is a block diagram illustrating a virtualization environment in which functions implemented by some embodiments of the present disclosure may be virtualized.

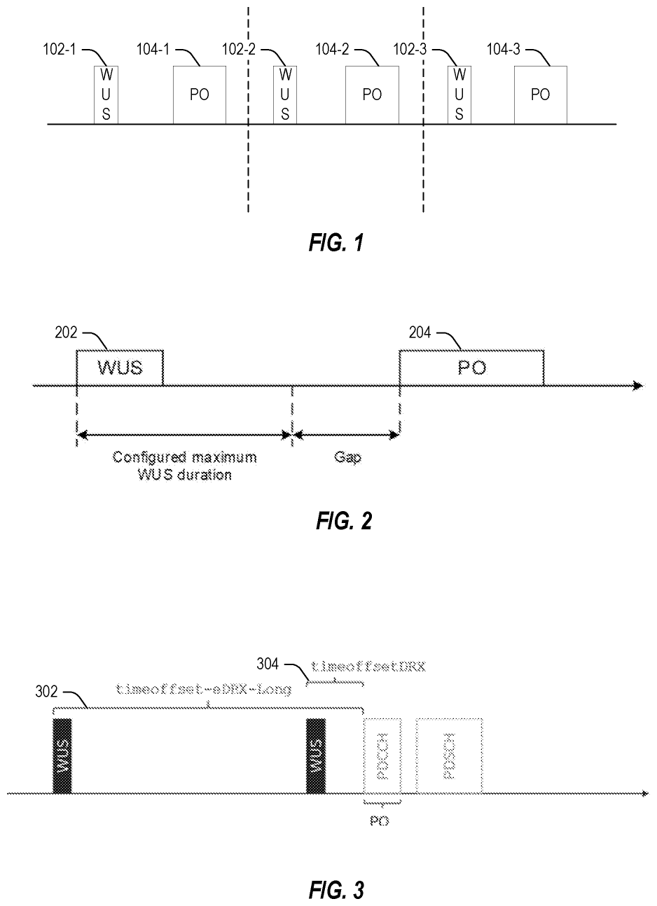

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s). A new physical signal, Low Power Wake Up Signal (LP-WUS), will be introduced in Rel-18 LP-WS to enable the Wake Up Receiver (WUR) to consume as little energy as possible. However, this makes the coexistence with the other Orthogonal Frequency Division Multiplexing (OFDM)-based Downlink (DL) signals problematic due to interference. The intention is to, upon paging to a User Equipment device (UE), flexibly be able to transmit the WUS to the UE when the main receiver of the UE is in a sleep state, but the WUS should not interfere with the other New Radio (NR) transmissions such as Physical Downlink Shared Channel (PDSCH) or Physical Downlink Control Channel (PDCCH) transmissions or have significant negative impact on the legacy performance.

Certain aspects of the disclosure and their embodiments may provide solutions to these or other challenges.

Certain embodiments may provide one or more of the following technical advantage(s).

Ensuring efficient coexistence of wake-up signals and other NR transmissions (e.g., data channels, control channels, reference signals).

Providing flexibility for addressing the tradeoff between coverage, performance, and UE power consumption by proper configuration of bandwidth-related parameters for WUR.

Minimizing impacts on base station (gNB) and UE implementations for supporting wake-up signals.

Efficient support of WUR to maximize the power saving gain while maintaining the UE coverage in various deployment scenarios.

The solution can be considered as a key enabler of battery-less (zero-energy) devices and energy harvesting operations towards Fifth Generation (5G) Advanced and Sixth Generation (6G).

There are three different alternatives for LP-WUS bandwidth (BW) when WUS is generated by an OFDM-transmitter:
1) Varying BW: WUS is using a fixed number of subcarriers (or Physical Resource Block-PRBs) and WUS BW is hence determined by the Sub-Carrier Spacing (SCS) used in the cell or bandwidth part, (BWP_(same as for NR)
2) Fixed BW: WUS SCS same as SCS on initial DL BWP:
a. Here a variable number of WUS PRBs may be needed to ensure WUS BW is within the maximum supported WUR bandwidth (e.g., 5-20 MHz).
3) Fixed BW: Single separate SCS always used for WUS, and hence fixed number of PRBs used. (E.g., a separate initial BWP with this SCS is configured for WUS, see below).
4) WUS SCS is different from SCS on initial DL BWP:
a. Here an indication to UEs of which SCS WUS applies (most naturally in the WUS configuration in SI) is needed.

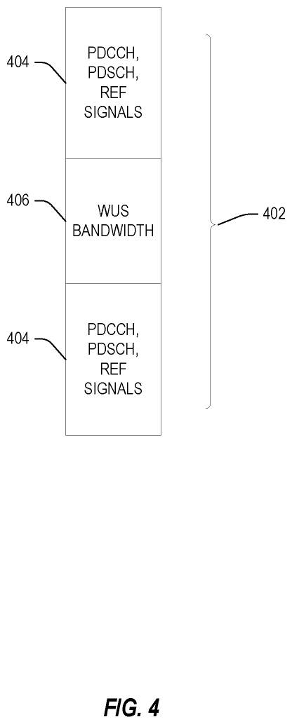

In the considered setup, an OFDM-transmitter generates a desired waveform such as a wake-up signal (WUS) which can be detected by a simple receiver such as a low power wake-up radio (WUR). Such signal (e.g., WUS) and other NR transmissions (e.g., PDSCH, PDCCH, reference signals) coexist within a channel bandwidth. This is depicted in FIG. 4 where out of an entire channel bandwidth 402, only a portion is the WUS signal in 406, whereas PDCCH, PDSCH, and other reference signals 404 take up the remainder of the channel bandwidth 402.

Let W be the WUS bandwidth (in e.g., Hz) and L be the number of OFDM subcarriers allocated to the WUS. Bandwidth can also be determined based on the number of subcarriers and subcarrier spacing (SCS), as well as any potential guard band (G, in Hz):

$$W = L \times SCS + G$$

Note that G can also be presented in terms of number of subcarriers.

In general, there is a design tradeoff in selecting the WUS bandwidth. A larger WUS bandwidth can improve the coverage (e.g., due to frequency diversity) at the cost of higher network overhead and UE power consumption. This present disclosure presents various options and representations for the WUS bandwidth.

### Varying WUS Bandwidth

In one embodiment, WUS bandwidth is presented in terms of a fixed number of subcarriers or resource blocks (RBs) with SCSs used for nominal NR transmissions. For example, WUS SCS is the same as SCS of synchronization signal (SS)/Physical Broadcast Channal (PBCH) block (SSB) in the cell, and WUS is transmitted in the legacy initial DL BWP (i.e., no separate initial DL BWP configure for WUR). In this case, WUS bandwidth is not fixed, and it scales with a defined SCS (i.e., different in different NW deployments and cell configurations). For example, WUS bandwidth in FRI can be:
24 RBs (equal to 288 subcarriers)
   4.32 MHz with 15 kHz SCS
   8.64 MHz with 30 kHz SCS
   17.32 MHz with 60 kHz SCS
12 RBs (equal to 144 subcarriers)
   2.16 MHz with 15 kHz SCS
   4.32 MHz with 30 kHz SCS
   8.64 MHz with 60 kHz SCS
8 RBs (equal to 96 subcarriers)
   1.44 MHz with 15 kHz SCS
   2.88 MHz with 30 kHz SCS
   5.76 MHz with 60 kHz SCS
4 RBs (equal to 48 subcarriers)
   0.72 MHz with 15 kHz SCS
   1.44 MHz with 30 KHz SCS
   2.88 MHz with 60 kHz SCS

That is, the number of PRBs used for WUS would be agreed and fixed in specification, and the WUS bandwidth would implicitly be determined from the SCS configured for WUS (e.g., included as part of the WUS configuration, legacy initial DL BWP, or separate initial DL BWP for WUR operation).

In another embodiment, WUS bandwidth is presented in terms of a pair of SCS and number of RBs. In this case, the number RBs can be different for different SCSs. For example:
N₁ RBs for 15 kHz SCS
N₂ RBs for 30 kHz SCS
N₃ RBs for 60 kHz SCS

Some non-limiting examples of N₁, N₂, N₃ are selected from {2, 4, 6, 8, 12, 16, 24, 36, 48}, where N₁, N₂, N₃ may or may not be the same.

In a related embodiment, for each SCS several number of RBs are defined for WUS bandwidth. For example:
For 15 kHz SCS, the possible numbers of RBs are {a₁, a₂, . . . a_{M}}
There are M possible values for number of RBs for 15 kHz SCS.
For 30 kHz SCS, the possible numbers of RBs are {b₁, b₂, . . . b_{K}}
There are K possible values for number of RBs for 30 KHz SCS.
For 60 kHz SCS, the possible numbers of RBs are {c₁, c₂, . . . c_{Q}}
   There are Q possible values for number of RBs for 60 KHz SCS.

In this case, the number of RBs used for WUS is configured in the cell and explicitly signaled to UEs. The indication can be done in a semi-static manner through the WUS configuration in System Information (SI) as common RRC signaling or via dedicated RRC configuration.

In any of the above embodiments, the UE after determining the WUS bandwidth for a SCS configuration, and alternatively the number of WUS PRBs, perform a WUS decoding attempt according to the determined WUS bandwidth.

### Fixed WUS Bandwidth

In another embodiment, a fixed bandwidth is defined for the WUS based on the maximum supported bandwidth of WUR. In this case, the WUS SCS can either be the same as SCS of the initial downlink (DL) bandwidth part (BWP), or a separate WUS initial DL BWP is configured for WUS with its own SCS. Hence, depending on the SCS, a variable number of WUS subcarriers (or RBs) will be needed to ensure WUS bandwidth is within the maximum supported WUR bandwidth.

For example, for around 5 MHz maximum WUS bandwidth:
15 kHz SCS for initial DL BWP: number of WUS RBs can be {27, 26, 25} depending on the guardband definition (e.g., whether is included in the WUS RBs or added separately).
30 kHz SCS for initial DL BWP: number of WUS RBs can be {14, 13, 12} depending on the guardband definition.
60 kHz SCS for initial DL BWP: number of WUS RBs can be {7, 6, 5} depending on the guardband definition.

In this case it could be statically configured (hard-coded) in specification which number of WUS RBs will be used in the cell for WUS transmission and the WUS BW would in this way be implicitly determined from the WUS SCS (which e.g., is configured in the WUS configuration in system information, or as part of the WUS initial BWP).

In a related embodiment, the number of RBs is defined for 15 kHz SCS based on the WUS bandwidth and scales according to the SCS of the initial DL BWP.

WUS SCS Different than SCS of Initial DL BWP

In some cases (as mentioned above), WUS SCS can be different from SCS of the initial DL BWP. Here, the UE is indicated which SCS for WUS transmission/reception applies. For example, such indication can be included in the WUS configuration, or made part of the separate WUS initial DL BWP, in either case signaled to UEs via System Information (common RRCor via dedicated RRC configuration).

In any of the above embodiments in this section, the UE after determining the WUS SCS configuration, performs a WUS reception according to the determined WUS SCS.

In addition, the following embodiments can be envisioned related to WUS bandwidth, number of RBs, and SCS:
WUS bandwidth and SCS can depend on the WUR architecture and UE capability. For example, two architectures corresponding to less-capable and more-capable receivers are defined, each with specific bandwidth, number of RBs, and supported SCS.
WUS bandwidth and SCS can depend on the operating band. For example, in some frequency bands WUS bandwidth is 5 MHz, in some other bands WUS bandwidth is 20 MHz.
WUS bandwidth and SCS can depend on the frequency position of the WUS within the system bandwidth. For example, the number of WUS RBs can be different if WUS is located in the middle of the carrier or at the edge of the carrier. This is because the amount of required WUS guardband can be different depending on the frequency position of the WUS.

### UE Capability Reporting

In a complementary embodiment, the WUS bandwidth, or the number of RBs used for WUS, supported by a UE depends on its capability. When the paging gNB receiving this UE capability from either AMF (CN paging) or anchor gNB (RAN paging) it can determine the WUS bandwidth and transmission format to use for this particular UE to ensure it can be received by the UE. Further, gNB can indicate which WUS bandwidths, number of WUS RBs, or WUS transmission formats are supported in the cell in system information, and if the UE does not support any of these it will not attempt to monitor WUS in the current cell (i.e., no WUR operation), nor will the gNB attempt to transmit WUS to the UE but instead use legacy paging procedure.

In case both the UE and the cell supports multiple WUS formats, it is required to have to rules to determine which format shall be used (to have a common understanding in UE and gNB to avoid mismatch):
Smallest WUS bandwidth, or Nr of WUS RBs, applied.
Largest WUS bandwidth, or Nr of WUS RBs, applied.
Preferred WUS bandwidth, or Nr of WUS RBs, indicated by the UE as part of UE capability reporting (ranking) and gNB follows this preference.
WUS bandwidth ranking, or Nr of WUS RBs ranking, included by the gNB in the list of supported alternatives in the system information configuration.
Etc.

If only one rule applies, it can be hard-coded in specification. If, however, different rules can be favorable depending on the circumstances, it can be made configurable which rule to apply. For example, rule 1 above (smallest WUS BW) can be applied in cases where WUS radio resource consumption is a concern, whereas rule 2 (largest WUS BW) can be applied in cases where the best WUS link performance and coverage want to be achieved (i.e., due to frequency diversity), in which case it can be made configurable in system information which rule should be applied by the UEs in the cell.

In a related embodiment, the maximum supported bandwidth of WUR depends on UE capability, i.e., reported to the network as part of the UE capability signaling. The network after knowing the maximum supported bandwidth of WUR configures the WUS bandwidth for a SCS configuration and/or WUS guardband configuration so that the WUS bandwidth is not larger than the maximum supported WUS bandwidth.

In any of the above embodiments in this section, the UE after determining the WUS bandwidth for a SCS configuration, performs a WUS reception according to the determined WUS bandwidth.

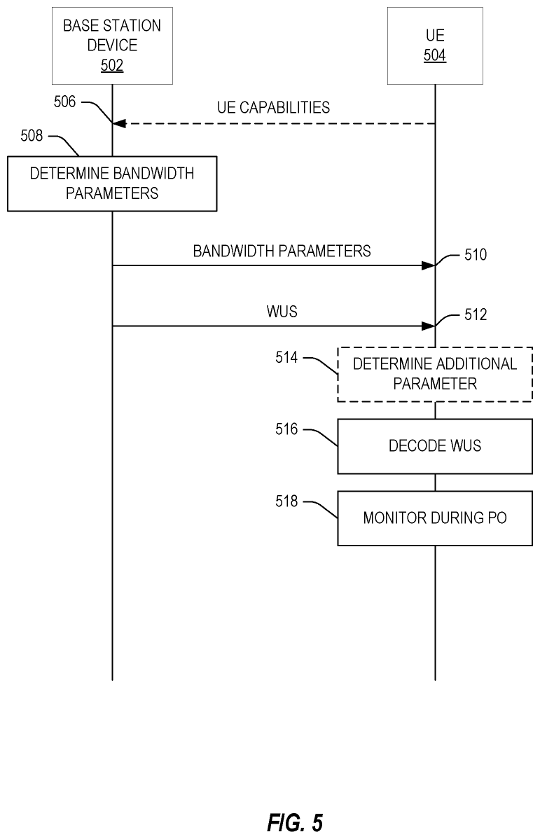

FIG. 5 depicts an example of a message sequence chart for configuring one or more bandwidth parameters of a WUS for a UE 504 by a base station device 502 in accordance with some embodiments of the present disclosure.

At 506, optionally, the UE 504 can signal the UE capabilities in a UE capability report to the base station device 502. The base station device can then, at 508, determine one or more bandwidth parameters for a WUS to the UE 504, and can optionally base the determination at least in part on the UE capabilities. In an embodiment, the determining the one more bandwidth parameters of the WUS is based on a maximum supported bandwidth of the WUR of the UE 504. In other embodiments, the number of subcarriers or resource blocks are determined based on a fixed SCS. In an embodiment, the fixed SCS is an SCS of an initial downlink bandwidth part. In other embodiments, the fixed SCS is different than an SCS of an initial downlink bandwidth part.

In an embodiment, the determining the one more bandwidth parameters is based on a fixed number of subcarriers or resource blocks and a variable SCS. In embodiment, the variable SCS is based on an SCS of a Synchronization Signal Physical Broadcast Channel block.

At 510, the base station device 502 can signal the bandwidth parameters to the UE 504. In an embodiment, the signaling the one or more bandwidth parameters to the UE 504 is via a System Information Block or via dedicated Radio Resource Control configuration.

At 512, after signaling the bandwidth parameters, the base station device 502 can then transmit the WUS to the UE 504.

Optionally at 514, the UE 504 can determine additional parameters that may not have been signaled explicitly. The base station device 502 may signal parameters implicitly, and the UE 504 can determine the actual bandwidth parameters based on the implicit signaling and/or other information. It is to be appreciated that while step 514 is shown as being after step 512, in FIG. 5, step 514 can happen anytime after receiving signaling about bandwidth parameters from the base station device 502 in step 510, and before receiving the WUS in step 512.

Based on the signaled bandwith parameters and any additional parameters, the UE 504 at step 516 can then perform a WUS decoding attempt, and in response to correctly decoding/identifying the WUS, the UE 504 can monitor for a subsequent downlink transmission during the paging occasion at step 518.

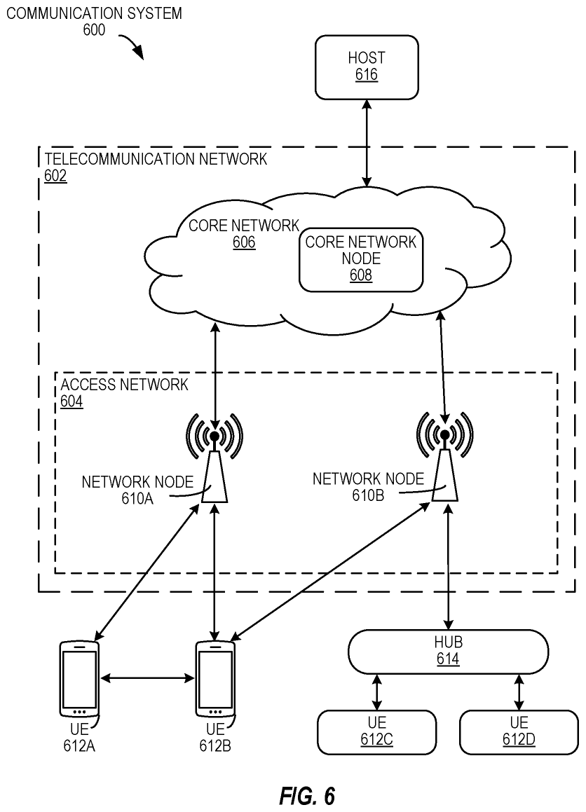

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections. In an embodiment, the network nodes 610 can perform the functions of the base station device 502 as described here.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602. The UEs 612 can perform the functions of the UE 504 as described herein.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e. being configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

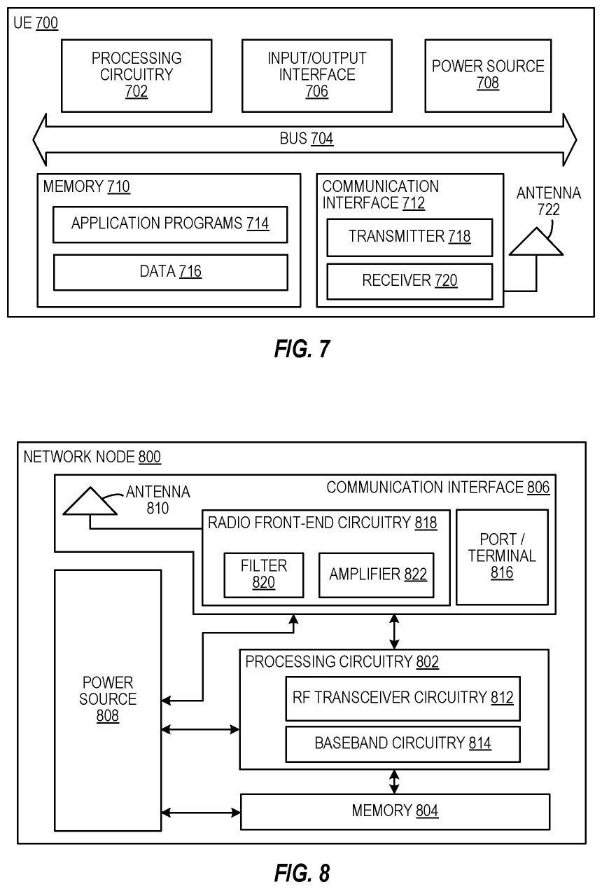

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a NodeB component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

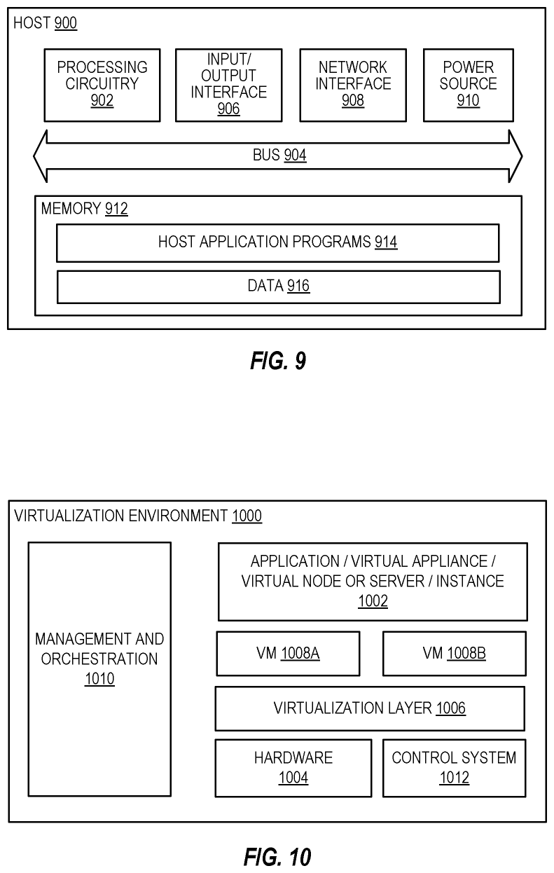

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 1012 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

The following include some of the embodiments of the present disclosure:

Embodiment 1: A method performed by a base station device (502) for configuring one or more bandwidth parameters of a Wake-Up Signal, WUS, for a Wake-Up Receiver, WUR, of a User Equipment, UE, (504) to reduce interference with other downlink transmissions, the method comprising: determining (508) one or more bandwidth parameters of the WUS; signaling (510) the one or more bandwidth parameters to the UE (504); and transmitting (512) the WUS based on the one or more bandwidth parameters of the WUS.

Embodiment 2: The method of embodiment 1, further comprising receiving (506) UE capability information from the UE (504); and determining (508) the one or more bandwidth parameters of the WUS based on the UE capability information.

Embodiment 3: The method of any of embodiments 1 to 2, wherein the one or more bandwidth parameters comprise one or more of: a number of subcarriers; a number of resource blocks; and Subcarrier Spacing, SCS.

Embodiment 4: The method of any of embodiments 1 to 3, wherein the determining the one more bandwidth parameters of the WUS is based on a maximum supported bandwidth of the WUR of the UE (504).

Embodiment 5: The method of embodiment 4, wherein the number of subcarriers or resource blocks are determined based on a fixed SCS.

Embodiment 6: The method of embodiment 5, wherein the fixed SCS is an SCS of an initial downlink bandwidth part.

Embodiment 7: The method of embodiment 5, wherein the fixed SCS is different than an SCS of an initial downlink bandwidth part.

Embodiment 8: The method of any of embodiments 1 to 3, wherein the determining the one more bandwidth parameters is based on a fixed number of subcarriers or resource blocks and a variable SCS.

Embodiment 9: The method of embodiment 8, wherein the variable SCS is based on an SCS of a Synchronization Signal Physical Broadcast Channel block, SSB.

Embodiment 10: The method of any of embodiments 1-9, wherein the signaling the one or more bandwidth parameters to the UE (504) is via a System Information Block or via dedicated Radio Resource Control configuration.

Embodiment 11: A base station device (502) that configures one or more bandwidth parameters of a Wake-Up Signal, WUS, for a Wake-Up Receiver, WUR, of a User Equipment, UE, (504) to reduce interference with other downlink transmissions, the base station device (502) comprising a radio interface and processing circuitry associated with the radio interface, wherein the processing circuitry is configured to cause the base station device (502) to determine (508) one or more bandwidth parameters of the WUS; signal (510) the one or more bandwidth parameters to the UE (504); and transmit (512) the WUS based on the one or more bandwidth parameters of the WUS.

Embodiment 12: The base station device (502) of embodiment 11, wherein the processing circuitry is further configured to cause the base station device (502) to receive (506) UE capability information from the UE (504); and determine (508) the one or more bandwidth parameters of the WUS based on the UE capability information.

Embodiment 13: The base station device (502) of any of embodiments 11 to 12, wherein the one or more bandwidth parameters comprise one or more of: a number of subcarriers; a number of resource blocks; and Subcarrier Spacing, SCS.

Embodiment 14: The base station device (502) of any of embodiments 11 to 13, wherein the determining the one more bandwidth parameters of the WUS is based on a maximum supported bandwidth of the WUR of the UE (504).

Embodiment 15: The base station device (502) of embodiment 14, wherein the number of subcarriers or resource blocks are determined based on a fixed SCS.

Embodiment 16: The base station device (502) of embodiment 15, wherein the fixed SCS is an SCS of an initial downlink bandwidth part.

Embodiment 17: The base station device (502) of embodiment 15, wherein the fixed SCS is different than an SCS of an initial downlink bandwidth part.

Embodiment 18: The base station device (502) of any of embodiments 11 to 13, wherein the determining the one more bandwidth parameters is based on a fixed number of subcarriers or resource blocks and a variable SCS.

Embodiment 19: The base station device (502) of embodiment 18, wherein the variable SCS is based on an SCS of a Synchronization Signal Physical Broadcast Channel block, SSB.

Embodiment 20: The base station device (502) of any of embodiments 11-19, wherein the signaling the one or more bandwidth parameters to the UE (504) is via a System Information Block or via dedicated Radio Resource Control configuration.

Embodiment 21: A method performed by a User Equipment, UE, (504) for detecting a Wake-Up Signal, WUS, for a Wake-Up Receiver, WUR, the method comprising: receiving (510) an indication from a base station device (502) of one or more bandwidth parameters associated with the WUS; decoding (516) a transmission based on the one or more bandwidth parameters resulting in a decoded transmission; and in response to the decoded transmission comprising a WUS, monitoring (518) for a subsequent downlink transmission.

Embodiment 22: The method of embodiment 21, further comprising: determining (514) an additional bandwidth parameter based on the one or more bandwidth parameters; and decoding (516) the transmission based on the one or more bandwidth parameters and the additional bandwidth parameter.

Embodiment 23: The method of any of embodiments 21 to 22, further comprising: receiving (510) the indication of the one or more bandwidth parameters via a System Information Block or via dedicated Radio Resource Control configuration.

Embodiment 24: The method of any of embodiments 21 to 23, wherein the one or more bandwidth parameters comprise one or more of: a number of subcarriers; a number of resource blocks; and Subcarrier Spacing, SCS.

Embodiment 25: The method of any of embodiments 21 to 24, further comprising: providing UE capability information to the base station device (502).

Embodiment 26: A User Equipment, UE, (504) for detecting a Wake-Up Signal, WUS, for a Wake-Up Receiver, WUR, the UE (504) comprising a radio interface and processing circuitry associated with the radio interface, wherein the processing circuitry is configured to cause the UE (504) to: receive (510) an indication from a base station device (502) of one or more bandwidth parameters associated with the WUS; decode (516) a transmission based on the one or more bandwidth parameters resulting in a decoded transmission; and in response to the decoded transmission comprising a WUS, monitor (518) for a subsequent downlink transmission.

Embodiment 27: The UE (504) of embodiment 26, wherein the processing circuitry is further configured to cause the base station device (502) to: determine (514) an additional bandwidth parameter based on the one or more bandwidth parameters; and decode (516) the transmission based on the one or more bandwidth parameters and the additional bandwidth parameter.

Embodiment 28: The UE (504) of any of embodiments 26 to 27, wherein the processing circuitry is further configured to cause the base station device (502) to: receive (510) the indication of the one or more bandwidth parameters via a System Information Block or via dedicated Radio Resource Control configuration.

Embodiment 29: The UE (504) of any of embodiments 26 to 28, wherein the one or more bandwidth parameters comprise one or more of: a number of subcarriers; a number of resource blocks; and Subcarrier Spacing, SCS.

Embodiment 30: The UE (504) of any of embodiments 26 to 29, wherein the processing circuitry is further configured to cause the base station device (502) to: provide UE capability information to the base station device (502).

Those skilled in the art will recognize improvements and modifications to the embodiments of the present disclosure. All such improvements and modifications are considered within the scope of the concepts disclosed herein.

1. A method performed by a base station device for configuring one or more bandwidth parameters of a Wake-Up Signal (WUS) for a Wake-Up Receiver (WUR) of a User Equipment (UE) to reduce interference with other downlink transmissions, the method comprising:
determining one or more bandwidth parameters of the WUS;
signaling the one or more bandwidth parameters to the UE; and
transmitting the WUS based on the one or more bandwidth parameters of the WUS.

2. The method of claim 1, further comprising:
receiving UE capability information from the UE; and
determining the one or more bandwidth parameters of the WUS based on the UE capability information.

3. The method of claim 1, wherein the one or more bandwidth parameters comprise one or more of:
a number of subcarriers;
a number of resource blocks; and
Subcarrier Spacing (SCS).

4. The method of claim 1, wherein the determining the one more bandwidth parameters of the WUS is based on a maximum supported bandwidth of the WUR of the UE.

5-7. (canceled)

8. The method of claim 1, wherein the determining the one more bandwidth parameters is based on a fixed number resource blocks and a variable SCS.

9. The method of claim 8, wherein the variable SCS is based on an SCS of a Synchronization Signal Physical Broadcast Channel block (SSB).

10. (canceled)

11. A base station device that configures one or more bandwidth parameters of a Wake-Up Signal (WUS) for a Wake-Up Receiver (WUR) of a User Equipment (UE) to reduce interference with other downlink transmissions, the base station device comprising a radio interface and processing circuitry associated with the radio interface, wherein the processing circuitry is configured to cause the base station device to:
determine one or more bandwidth parameters of the WUS;
signal the one or more bandwidth parameters to the UE; and
transmit the WUS based on the one or more bandwidth parameters of the WUS.

12. The base station device of claim 11, wherein the processing circuitry is further configured to cause the base station device to:
receive UE capability information from the UE; and
determine the one or more bandwidth parameters of the WUS based on the UE capability information.

13. The base station device claim 11, wherein the one or more bandwidth parameters comprise one or more of:
a number of subcarriers;
a number of resource blocks; and
Subcarrier Spacing (SCS).

14. The base station device of claim 11, wherein the determining the one more bandwidth parameters of the WUS is based on a maximum supported bandwidth of the WUR of the UE.

15-17. (canceled)

18. The base station device of claim 11, wherein the determining the one more bandwidth parameters is based on a fixed number of resource blocks and a variable SCS.

19. The base station device of claim 18, wherein the variable SCS is based on an SCS of a Synchronization Signal Physical Broadcast Channel block (SSB).

20. (canceled)

21. A method performed by a User Equipment (UE) for detecting a Wake-Up Signal (WUS) for a Wake-Up Receiver (WUR), the method comprising:
receiving an indication of one or more bandwidth parameters associated with the WUS from a base station device;
decoding a transmission based on the one or more bandwidth parameters, resulting in a decoded transmission comprising the WUS; and
in response to the decoded transmission comprising the WUS, monitoring for a subsequent downlink transmission.

22. The method of claim 21, further comprising:
determining an additional bandwidth parameter based on the one or more bandwidth parameters; and
decoding the transmission based on the one or more bandwidth parameters and the additional bandwidth parameter.

23. The method of claim 21, further comprising:
receiving the indication of the one or more bandwidth parameters via a System Information Block or via dedicated Radio Resource Control configuration.

24. The method of claim 21, wherein the one or more bandwidth parameters comprise one or more of:
a number of subcarriers;
a number of resource blocks; and
Subcarrier Spacing (SCS).

25. (canceled)

26. A User Equipment (UE) for detecting a Wake-Up Signal (WUS) for a Wake-Up Receiver (WUR), the UE comprising a radio interface and processing circuitry associated with the radio interface, wherein the processing circuitry is configured to cause the UE to:
receive an indication of one or more bandwidth parameters associated with the WUS from a base station device;
decode a transmission based on the one or more bandwidth parameters, resulting in a decoded transmission comprising the WUS; and
in response to the decoded transmission comprising the WUS, monitor for a subsequent downlink transmission.

27. The UE of claim 26, wherein the processing circuitry is further configured to cause the base station device to:
determine an additional bandwidth parameter based on the one or more bandwidth parameters; and
decode the transmission based on the one or more bandwidth parameters and the additional bandwidth parameter.

28. The UE of claim 26, wherein the processing circuitry is further configured to cause the base station device to:
receive the indication of the one or more bandwidth parameters via a System Information Block or via dedicated Radio Resource Control configuration.

29. The UE of claim 26, wherein the one or more bandwidth parameters comprise one or more of:
a number of subcarriers;
a number of resource blocks; and
Subcarrier Spacing (SCS).

30. (canceled)
